(19) United States
(12) Patent Application Publication
(10) Pub. No.: US 2022/0367948 A1
(43) Pub. Date: Nov. 17, 2022

(54) TUBULAR BATTERY CASE WITH WELDED COVERS

(71) Applicant: Medtronic, Inc., Minneapolis, MN (US)

(72) Inventors: Joseph J. Viavattine, Vadnais Heights, MN (US); Hailiang Zhao, Plymouth, MN (US)

(21) Appl. No.: 17/316,929

(22) Filed: May 11, 2021

(51) Int. Cl. H01M 50/169; H01M 50/30; H01M 50/107

(52) U.S. Cl. CPC H01M 50/169; H01M 50/30; H01M 50/107

(57) ABSTRACT

A battery comprising a tubular battery housing having a first end and a second end. The first end and the second end can have a substantially same inner diameter and a substantially same outer diameter. The battery further comprises a battery cell within the tubular battery housing. The battery further comprises a top battery cover coupled to the first end and a bottom battery cover coupled to the second end to form a substantially sealed enclosure around the battery cell. Method for manufacturing the battery are also described.

### FIELD

The present technology is generally related to batteries for use with implantable medical devices. More specifically, the present technology relates to tubular batteries manufactured with welded covers.

### BACKGROUND

As implantable medical device (IMD) technology advances, issues such as IMD battery longevity, IMD size and shape, IMD mass, and patient comfort remain key considerations in the IMD design process. Battery size and capacity, for example, significantly impact the physical configuration of the IMD and the duration of service time within the patient before battery replacement or recharge is required. Batteries in use today use a deep drawing process to form the battery case. However, the deep drawing process can result in inefficiencies in space usage. Further, the deep drawing process can introduce defects into the case and can limit the features that can be included in the battery covers.

### SUMMARY

The techniques of this disclosure generally relate to battery apparatuses.

In one aspect, the present disclosure provides a battery having a tubular battery housing. The tubular battery housing has a first end and a second end. The first end and the second end have a substantially same inner diameter and a substantially same outer diameter. The battery further includes a battery cell within the tubular battery housing. The battery further includes a top battery cover and a bottom battery cover coupled to respective ends to form a substantially sealed enclosure around the battery cell. The bottom battery cover can be welded to the tubular battery housing.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF DRAWINGS

FIG. 1 is a diagram of an example therapy system including an implantable cardiac device (ICD).

FIG. 2 is a block diagram of an ICD that includes a battery in accordance with embodiments.

FIG. 3 is an illustration of a tubular battery housing in accordance with embodiments.

FIG. 4 is an illustration of a feedthrough with a tubular battery housing in accordance with embodiments.

FIG. 5 is an exploded view of battery components in accordance with embodiments.

FIG. 6 illustrates a bottom cover in accordance with embodiments.

FIG. 7 is a flow diagram of a method for manufacturing a battery in accordance with embodiments.

### DETAILED DESCRIPTION

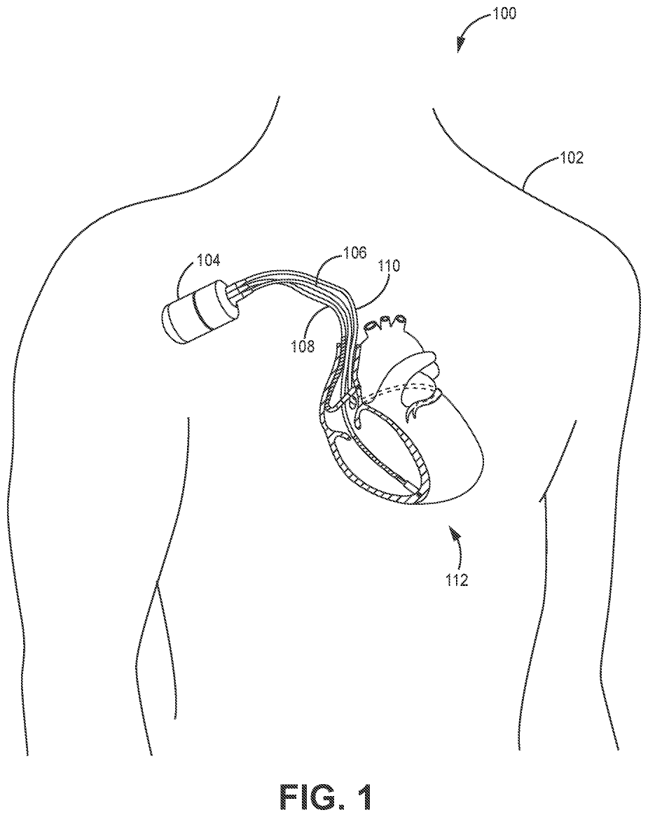

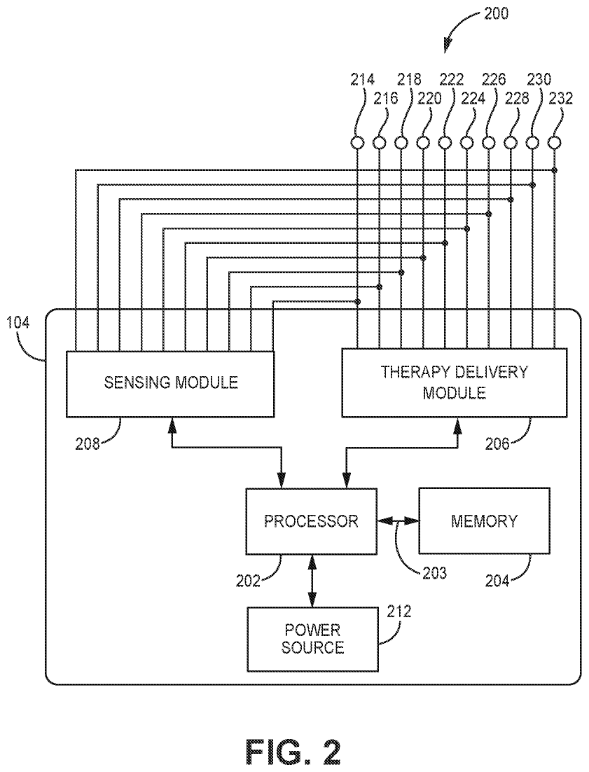

The batteries described herein may be used in any suitable device, such as an implantable medical device. The batteries described herein may be used in any suitable implantable medical device. Examples of suitable implantable medical devices include implantable devices that provide therapy to, or sense signals from, a heart of a patient; implantable devices that provide therapy to, or sense signals from, a portion of a central or peripheral nervous system of a patient, implantable devices that deliver therapeutic fluids to a patient, and the like. More specific examples of implantable medical devices that may employ batteries as described herein include implantable pacemakers, cardioverters, defibrillators, deep brain stimulators, spinal cord stimulators, and drug pumps. For purposes of context, an implantable cardiac device (ICD) is discussed regarding FIGS. 1-2 below.

FIG. 1 is a conceptual diagram illustrating an example system 100 that provides therapy to patient 102. Therapy system 100 includes ICD 104, which is connected to leads 106, 108 and 110. ICD 104 may be, for example, a device that provides cardiac rhythm management therapy to heart 112, and may include, for example, an implantable pacemaker, cardioverter, and/or defibrillator that provide therapy to heart 112 of patient 102 via electrodes coupled to one or more of leads 106, 108 and 110. Leads 106, 108, 110 extend into the heart 112 of patient 102 to sense electrical activity of heart 112 and/or deliver electrical stimulation to heart 112.

FIG. 2 is a block diagram of an ICD 104 that includes a power source 212 comprising a battery in accordance with embodiments. The ICD 200 includes a processor 202, memory 204, stimulation generator 206, sensing module 208, and power source 212. The processor 202 may communicate with memory 204 over an interconnect 203 (e.g., a bus). The interconnect 203 may include any number of technologies, including industry standard architecture (ISA), extended ISA (EISA), peripheral component interconnect (PCI), peripheral component interconnect extended (PCIx), PCI express (PCIe), or any number of other technologies. The interconnect 203 may be a proprietary bus.

Stimulation generator 206 is electrically coupled to electrodes 214, 216, 218, 220, 222, 224, 226, 228, 230, 232 e.g., via conductors of the respective lead 106, 108, 110, or, in the case of housing electrode 230, via an electrical conductor disposed within housing of ICD 104. Stimulation generator 206 is configured to generate and deliver electrical stimulation therapy to heart 112 to manage a rhythm of heart 112. Electrodes 214, 216, 218, 220, 222, 224, 226, 228, 230, 232 can include ring electrodes or helical electrodes, for example, although embodiments are not limited thereto. Sensing module 208 monitors signals from at least one of electrodes 214, 216, 218, 220, 222, 224, 226, 228, 230, 232 to monitor electrical activity of heart 112, e.g., via an EGM signal.

The various components of ICD 104 are coupled to power source 212, which may include a rechargeable or non-rechargeable battery. A non-rechargeable battery may be selected to last for several years, while a rechargeable battery may be inductively charged from an external device, e.g., on a daily or weekly basis. Examples of a rechargeable battery include, but are not limited to, a lithium-ion battery, a lithium/silver vanadium oxide battery, a lithium polymer battery, or a supercapacitor.

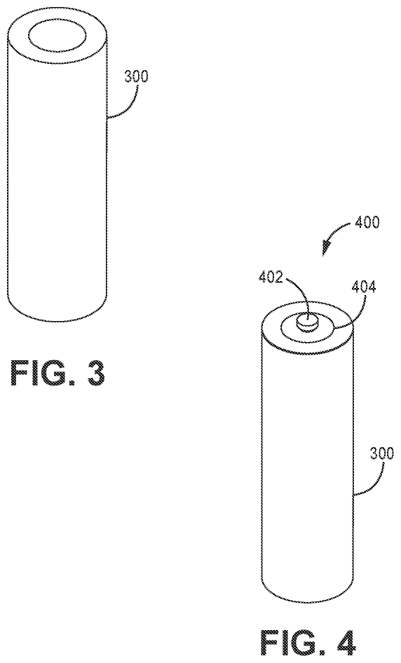

FIG. 3 is an illustration of a tubular battery housing 300 in accordance with embodiments. Power source 212 may include the tubular battery housing 300. The battery housing 300 can comprise metallic alloys and provide the ground or negative terminal of a tubular battery. The battery housing 300 can have an open first end and an open second end and the battery housing 300 can be substantially cylindrical having a uniform inner diameter, a uniform outer diameter and uniform wall thickness throughout a length of the battery housing 300. While the battery housing 300 is shown and described as having a generally cylindrical shape, however, the battery housing 300 can have other cross-sectional shapes including, but not limited to rectangular, triangular, square, hexagonal, and octagonal shapes. As referred to herein, the term tubular does not indicate to any particular cross-sectional shape, but only indicates a component including a hollow elongated body.

The battery housing 300 can have a length greater than its diameter. As examples, the length of the battery housing 300 can be about 1.1 times to about 10 times the diameter of the battery housing 300. As an example, the length of the battery housing 300 can be about 50-70 millimeters and the diameter of the battery housing can be about 15-25 millimeters. In examples, the battery housing 300 can be about 65 millimeters in length and about 19 millimeters in diameter.

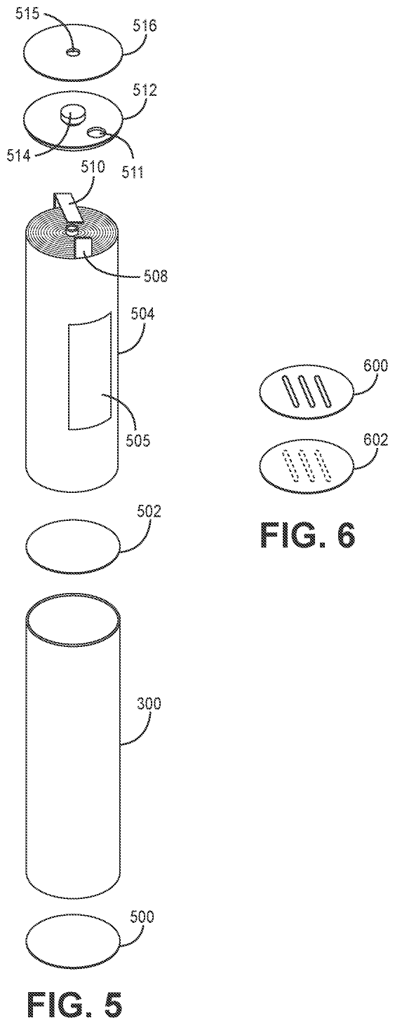

The battery housing 300 having an open first end and an open second end can be formed by any suitable process. For example, the battery housing 300 can be formed by extruding or rolling and seam sealing, which removes the need for drying or other processes associated with deep drawing. The battery housing 300 can be formed in a machining process from a solid base stock. The battery housing 300 can be formed from a drawn tubing. Shrink wrapping or other surface can be provided over the battery housing 300. The shrink wrapping can prevent electrical shorting and provide an insulator for the battery. The shrink wrapping can be heat shrinked to the outer surface of the battery housing 300. In some examples, such a shrink wrapping can be applied around the battery 400 after assembly as further detailed with reference to FIG. 5.

FIG. 4 is an illustration of a battery 400 having a feedthrough 402 with a tubular battery housing 300 in accordance with embodiments. In an example, the feedthrough 402 can connect battery cell 504 (FIG. 5) to form a positive battery terminal for the battery 400. The feedthrough 402 is electrically isolated from other components of the battery 400 by an insulator 404.

FIG. 5 is an exploded view of battery 400 components in accordance with embodiments and illustrates distinctions between currently available batteries having deep drawn housings. Deep drawn battery housings result in a closed bottom end, with welded or otherwise attached top covers. The deep drawing process results in an integral body comprising the battery housing and bottom end (e.g., a deep drawn can), which can include a slight tapering toward the bottom end (and sometimes additional space above the bottom end) to allow easier insertion of a bottom insulator and battery cell. The bottom insulator can serve to protect the battery cell from touching or contacting the bottom end. In some available batteries, similar space or tapering is left above the battery cell. Typical tapering can include about 0.5 to 2 degrees of taper within the deep-drawn can. A deep drawn can may also include a gradient thickness change in the side wall from top to bottom, which can be caused by the drawing process. This tapering and extra space allowance can lead to space usage inefficiencies. Further, it can be difficult to manufacture deep drawn battery housings with bottom ends having small thicknesses, which may be desirable for use in medical device implementations.

These and other problems can be reduced or eliminated by removing the deep drawing process from battery manufacturing operations, and instead coupling the bottom cover 500 to the battery housing 300. The bottom cover 500 may be coupled to the battery housing 300 in any suitable manner. For example, the bottom cover 500 may be coupled to the battery housing by welding. Further, by removing deep drawing processes from battery manufacture, the thickness of the bottom cover 500 can be made independent of the thickness of the battery housing 300. Additionally, by removing the constraints of a single deep drawn piece that incorporates both a bottom end and tubular housing, further design optimizations can be implemented on one or both of the bottom cover 500 and tubular housing 300. For example, the bottom cover 500 can be formed with scoring, machine marks, or other features to provide weak points for venting the battery 400. Further, a vent can be added into the bottom cover 500. Expansion can be controlled through the bottom cover 500 due to the ability to control the thickness of the bottom cover 500 independently from the housing 300 thickness. For example, if higher internal pressures are expected warranting a thick bottom for the case to minimize expansion of the bottom cover, the bottom cover 500 can be thickened separately from the side walls. This results in a case wall that allows for additional battery capacity (e.g., more electrolyte can be added).

The top cover 512, the bottom cover 500, and the battery housing may have any suitable thicknesses and can be the same or different. In embodiments, the top cover 512 can be thicker than the bottom cover 500 or than the battery housing 300 to prevent deformations of the battery under pressure. In some examples, walls of a battery housing 300 can be about 0.008 to 0.016 inches (or 0.2 to 0.4 millimeters) thick. In some examples, the top cover 512 can be about 0.5 inches (or 12.7 millimeters) thick. The top cover 512 can be made thinner if feedthrough 402 is not integrated into the top cover 512. For example, the top cover 512 can be about 0.008 to 0.07 inches (or 0.2 to 1.778 millimeters) thick in absence of a feedthrough. The bottom cover 500 can be about 0.008-0.04 inches (or 0.2 to 1.016 millimeters) thick. In examples, the bottom cover 500 can be thinner than the walls of the battery housing 300. In examples, the bottom cover 500 can be thinner than the walls of the battery housing 300 to provide a weak point for venting of the battery. The top cover 512, the bottom cover 500, and the battery housing 300 can all be of same thicknesses as each other in some embodiments. In some embodiments, any of the top cover 512, the bottom cover 500 and the battery housing 300 can be thinner or thicker than any other of the top cover 512, bottom cover 500 and battery housing 300. This allows for independent design of each of the top cover 512, bottom cover 500 and battery housing 300.

Similarly to the battery housing 300, the top cover 512, and bottom cover 500 can comprise metallic alloys and provide the ground or negative terminal of the tubular battery. The housing 300 can be welded to bottom cover 500 and top cover 512 or otherwise attached to form a substantially-sealed enclosure encasing battery cell 504.

Battery cell 504 is depicted as being arranged in a jelly roll configuration with tabs 508 and 510, although embodiments are not limited to a jelly roll configuration for battery cell 504. In a jelly roll configuration, an insulating sheet (not shown in FIG. 5) is laid down, then a thin layer (not shown in FIG. 5) of an anode material is laid down, a separator layer is applied, and a cathode material is layered (not shown in FIG. 5) on top. The layers are rolled and inserted into housing 300. A bottom insulator 502 can prevent the battery cell 504 from touching or contacting the bottom cover 500. In an example, one tab 508 may connect to cathode material, and the other tab 510 may connect to anode material of the battery cell 504. Battery cell 504 may comprise lithium/silver vanadium oxide. Adhesive tape 505 can be included to hold the outer edge of the jelly roll in place.

Top cover 512 includes feedthrough 514, which can be the same or similar to the feedthrough 402 (FIG. 4) to provide electrical contact to the battery cell 504 through hole 515. Insulator 516 (which can be similar to insulator 404 (FIG. 4)) is applied over the top cover 512. Opening 511 allows access for an electrolyte to be poured or provided to the battery cell 504 before the top cover 512 is welded or otherwise attached to the housing 300. In some examples, as mentioned earlier herein with reference to FIG. 3, shrink wrapping can be applied over the entire battery 400. A header insulator (not shown in FIG. 5) can be inserted between the battery cell 504 and top cover 512 to retain the battery cell 504 in position against the top cover 512.

FIG. 6 is a diagram of a bottom cover 500 in accordance with embodiments. The bottom cover 500 can include vents 600. In addition or in the alternative, the bottom cover 500 can include scoring 602. At least these features (e.g., scoring 602, vents 600, or other machine marks) can serve as a vent to balance high internal battery pressures by providing weak points through which the battery can be vented.

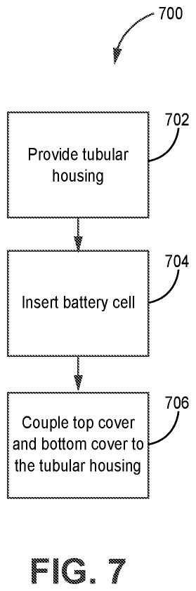

FIG. 7 is a flow diagram of a method 700 for manufacturing a battery 400 in accordance with embodiments. Reference is made to elements of the battery 400 described above with reference to FIG. 3-5. The method 700 can begin with operation 702 by providing a tubular battery housing 300 having a first end and a second end. The first end and the second end can have a substantially same inner diameter and a substantially same outer diameter. The tubular battery housing 300 can be manufactured using any suitable process, such as an extrusion process, or a rolling process.

The method 700 can continue with operation 704 with inserting a battery cell 504 within the tubular battery housing 300. The method 700 can continue with operation 706 with coupling a top cover 512 to the first end and coupling a bottom battery cover 500 to the second end to form a substantially sealed enclosure around the battery cell 504. The top cover 512 and the bottom cover 500 can be coupled by any suitable process, such as welding. The bottom cover 500 can include features for thinning or weaken the bottom cover 500 in spots, for ventilation or other uses. Such features can include vents, scoring, or other features and mechanisms. The top cover 512, bottom cover 500, and tubular housing 300 can be provided in varying thicknesses. For example, the bottom cover 500 can be provided with a thickness less than that of the tubular battery housing 300 and the tubular battery housing 300 can be provided with a thickness less than that of the top cover 512.

Various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Accordingly, the term “processor” as used herein may refer to any of the foregoing structure or any other physical structure suitable for implementation of the described techniques. Also, the techniques could be fully implemented in one or more circuits or logic elements.

What is claimed is:

1. A battery comprising:
a tubular battery housing having a first end and a second end, the first end and the second end having a substantially same inner diameter and a substantially same outer diameter;
a battery cell within the tubular battery housing; and
a top battery cover coupled to the first end and a bottom battery cover coupled to the second end to form a substantially sealed enclosure around the battery cell.

2. The battery of claim 1, wherein the bottom battery cover is welded to the tubular battery housing.

3. The battery of claim 1, wherein the bottom battery cover includes a vent.

4. The battery of claim 1, wherein the bottom battery cover includes scoring.

5. The battery of claim 1, wherein the tubular battery housing has a housing thickness of about 0.008-0.016 inches.

6. The battery of claim 5, wherein the bottom battery cover has a thickness of about 0.008-0.04 inches.

7. The battery of claim 6, wherein the bottom battery cover has a thickness less than the housing thickness.

8. The battery of claim 1, wherein the top battery cover has a thickness of about 0.5 inches.

9. The battery of claim 8, wherein the top battery cover includes a feedthrough.

10. A method for manufacturing a battery, the method comprising:
providing a tubular battery housing having a first end and a second end, the first end and the second end having a substantially same inner diameter and a substantially same outer diameter, the tubular battery housing having a housing thickness;
inserting a battery cell within the tubular battery housing; and
coupling a top battery cover to the first end and coupling a bottom battery cover to the second end to form a substantially sealed enclosure around the battery cell.

11. The method of claim 10, wherein the bottom battery cover is coupled by welding.

12. The method of claim 10, wherein the tubular battery housing is manufactured using an extrusion process.

13. The method of claim 10, wherein the tubular battery housing is manufactured using a rolling process.

14. The method of claim 10, where the tubular battery housing is manufactured in a machining process from a solid base stock.

15. The method of claim 10, wherein the tubular battery housing includes a drawn tubing.

16. The method of claim 10, further comprising providing a vent in the bottom battery cover.

17. The method of claim 10, further comprising scoring the bottom battery cover.

18. The method of claim 10, further comprising:
providing the bottom battery cover with a bottom cover thickness less than the housing thickness.

19. The method of claim 10, further comprising:
providing the bottom battery cover with a bottom cover thickness greater than the housing thickness.

20. The method of claim 17, further comprising:
providing the top battery cover with a top cover thickness greater than the housing thickness.

21. The method of claim 17, further comprising:
providing the top battery cover with a top cover thickness less than the housing thickness.

22. An implantable medical device (IMD) comprising:
a battery comprising:
a tubular battery housing having a first end and a second end, the first end and the second end having a substantially same inner diameter and a substantially same outer diameter;
a battery cell within the tubular battery housing; and
a top battery cover coupled to the first end and a bottom battery cover coupled to the second end to form a substantially sealed enclosure around the battery cell; and
a processor coupled to receive power from the battery.

23. The IMD of claim 22, wherein the bottom battery cover is welded to the tubular battery housing.
